(19) United States
(12) Patent Application Publication
(10) Pub. No.: US 2005/0131940 A1
(43) Pub. Date: Jun. 16, 2005

(54) Dynamic method of inserting data a the nodes of an optical transmission network

(76) Inventors: Nicolas Le Sauze, Bures-Sur-Yvette (FR); Emmanuel Dotaro, Verrieres Le Buisson (FR)

Correspondence Address: SUGHRUE MION, PLLC, 2100 PENNSYLVANIA AVENUE, N.W., SUITE 800, WASHINGTON, DC, 20037, US

(21) Appl. No.: 10/509,102

(22) PCT Filed: Mar. 21, 2003
(86) PCT No.: PCT/FR03/00899

(30) Foreign Application Priority Data
Mar. 28, 2002 (FR) 02/03912

(51) Int. Cl. G06F 17/00

(52) U.S. Cl. 707/104.1

(57) ABSTRACT

Dynamic method of adding data at the nodes of a fiber optic transmission network comprising at least one source node, one destination node and a plurality of intermediate nodes, the nodes being connected by a fiber optic connection. The method comprises the steps of creating at the source node an optical resource comprising portions containing data packets addressed to said destination node and free portions that may be occupied by packets supplied by each of said intermediate nodes, when said resource transits an intermediate node, detecting if said resource comprises free portions if said intermediate node has at least one data packet to transmit, and adding said data packet to a free portion of the frame if said free portion may contain said data packet.

The present invention relates to the technology of data transmission in fiber optic transmission networks and relates more particularly to a dynamic method of adding data at the nodes of a fiber optic transmission network.

For many years network operators have been investing in the transport of information in optical form, because of the inherent advantages of fiber optic transmission. This is because the transport capacity of fibers has increased considerably thanks to the adoption of the dense wavelength division multiplexing (DWDM) technique, which transmits different wavelengths simultaneously and therefore increases the number of completely independent transmission channels in the same physical fiber. Tens or even hundreds of wavelengths may therefore be combined and transported in the same propagation medium, responding to the formidable increase in demand for bandwidth resulting from the expansion of the Internet and public and private data transport networks.

The essential function of a communication network is therefore to direct and orient streams of information to be transported to their final destination via the nodes of the network, of which there is often a very large number. A key device at a network node is therefore a switch such as an Optical Xcross Connect (OXC) or an optical add and drop multiplexer (OADM), the function of which, as its name suggests, is to add and drop local traffic in the optical domain (for example at the entry and exit point of a secondary network) while the remainder of the traffic is transmitted unchanged to its final destination via other nodes of the network. Of course, this add and drop function must be possible essentially in the optical domain to avoid having to have recourse to the electrical circuits of conventional electronic means, which would imply the use of costly opto-electronic converters. In the optical circuit technique, at least one local information carrier wavelength is entirely reserved for communication between two nodes of a network. It may therefore be dropped and added in the optical domain at the nodes concerned. However, this has the major drawback that the bandwidth corresponding to the wavelengths reserved in this way may be used only by the nodes in question. A de facto fixed connection (path) is set up between them. If they do not use all of the corresponding bandwidth, which is generally the case as the latter must be chosen to suit the peak traffic, the unused bandwidth is lost, even though it could be used to transport data between other nodes of the network. The bandwidth granularity is therefore one wavelength. Furthermore, this method implies the use of a large number of wavelengths, which limits the maximum size of a network to around ten nodes or a few tens of nodes, since the number of connections to be made increases with the square of the number of nodes constituting the network.

Better use of the overall bandwidth may be obtained with another, more complex technique known as optical burst switching (OBS). This technique essentially consists in exchanging data between nodes of the network in the form of bursts of data. The nodes of the network must therefore be reconfigured for the duration of the bursts. Thus the available wavelengths may be used more effectively as they are not assigned in a fixed manner to a pair of nodes. The information exchange granularity becomes that of the bursts. This type of network implies the use of optical switches, which are relatively slow to reconfigure, as a consequence of which, for the system to be sufficiently efficient, the bursts must have a long duration compared to the duration of the packets of data to be exchanged. This leads to having to group a sufficient number of data packets to form a burst, which usually results in high latency in the transmission of data between nodes or, once again, in underuse of the bursts and therefore of the overall bandwidth. It should additionally be noted that, as with fixed assignment of wavelengths, the intermediate nodes may neither add nor drop data in the bursts circulating between two nodes.

For this reason the object of the invention is to provide a method of inserting data generated locally, on the fly, at each node of a fiber optic transmission network, if all the bandwidth to a given destination node has not been entirely used.

The invention therefore provides a dynamic method of adding data at the nodes of a fiber optic transmission network comprising at least one source node, one destination node and a plurality of intermediate nodes, said nodes being connected by a fiber optic connection, said method comprising the following steps:
a) creating at the source node an optical resource (wavelength, macroslot or macropacket) comprising portions containing data packets addressed to said destination node and free portions that may be occupied by packets supplied by each of said intermediate nodes,
b) when said resource transits an intermediate node, detecting if said resource comprises free portions if said intermediate node has at least one data packet to transmit, and
c) adding said data packet to a free portion of the resource if said free portion may contain said data packet.

A first embodiment of the above method is characterized in that:
the step b) consists in detecting the absence of optical signals; and
the step c) consists in transmitting said data packet over the network if the step b) has detected absence of any optical signal for a time corresponding at least to the time of said data packet.

A second embodiment of the above method is characterized in that:
said optical resource is a macropacket comprising a header for at least determining the destination of said macropacket and data packets supplied at each of said intermediate nodes; and
the step b) consists in determining the free portions of said macropacket by analyzing the content of said header.

Because free spaces are detected either by simple continuous detection of the power of the optical resource or by simple analysis of the header of the macropacket itself, both of the above embodiments are able to insert a data packet into a data macropacket without it being necessary to analyze individually the packets already contained in the macropacket.

The aims, subject matter and features of the invention will become more clearly apparent on reading the following description, which is given with reference to the drawings, in which:

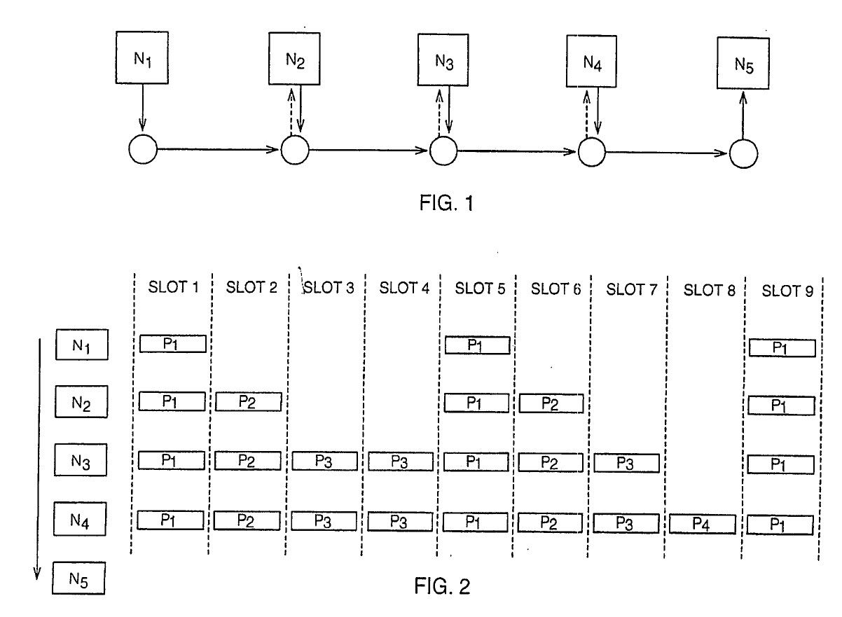

FIG. 1 is a block schematic of a portion of a fiber optic network implementing a method of the invention,

FIG. 2 is a diagram representing the addition of data packets into an optical frame in transit in the network shown in FIG. 1,

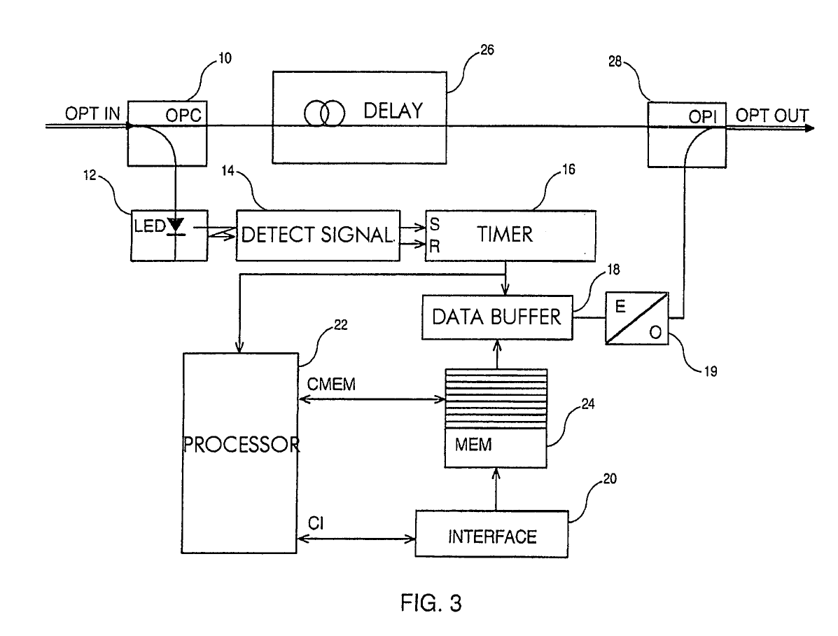

FIG. 3 is a block diagram representing an optical data addition device in the optical resource at the interface of an intermediate node,

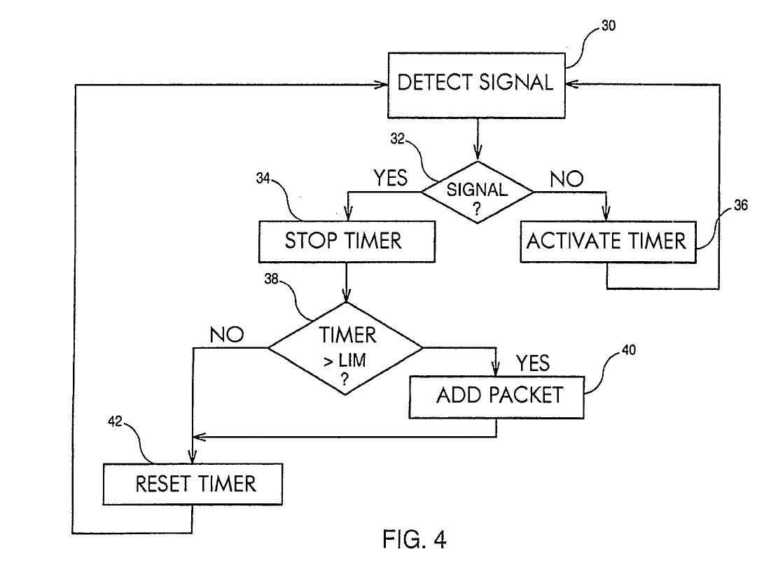

FIG. 4 is a flowchart representing the process steps executed in the device shown in FIG. 3,

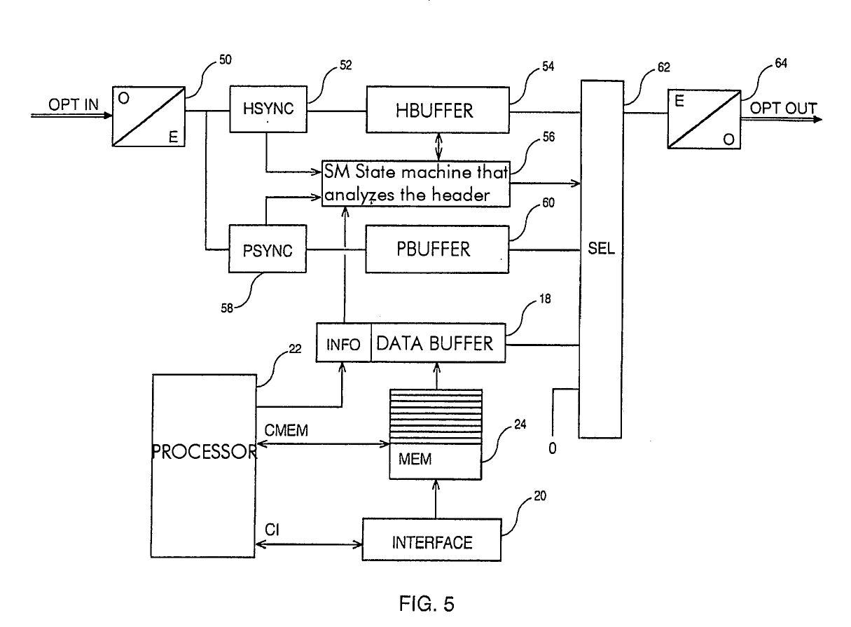

FIG. 5 is a block diagram representing an electrical device for adding data to the frame at the interface of an intermediate node,

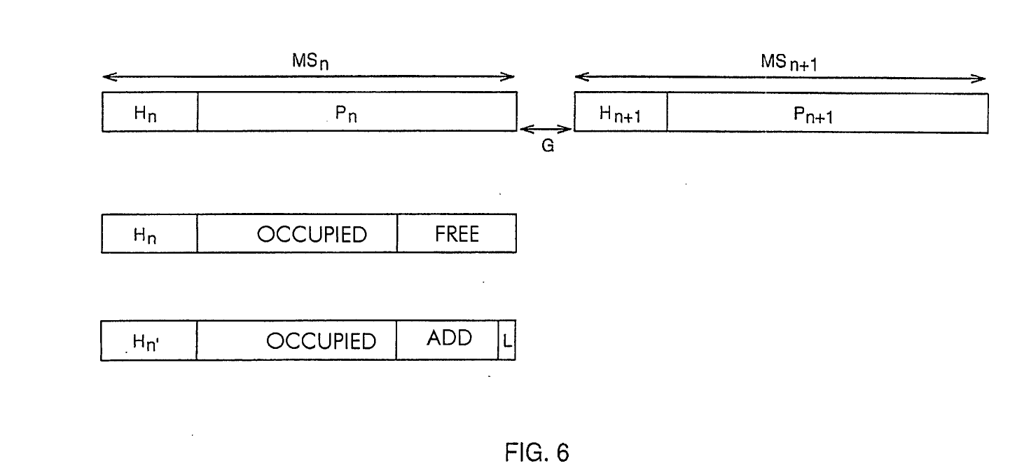

FIG. 6 is a diagram representing the addition of data packets to a macroslot of fixed size,

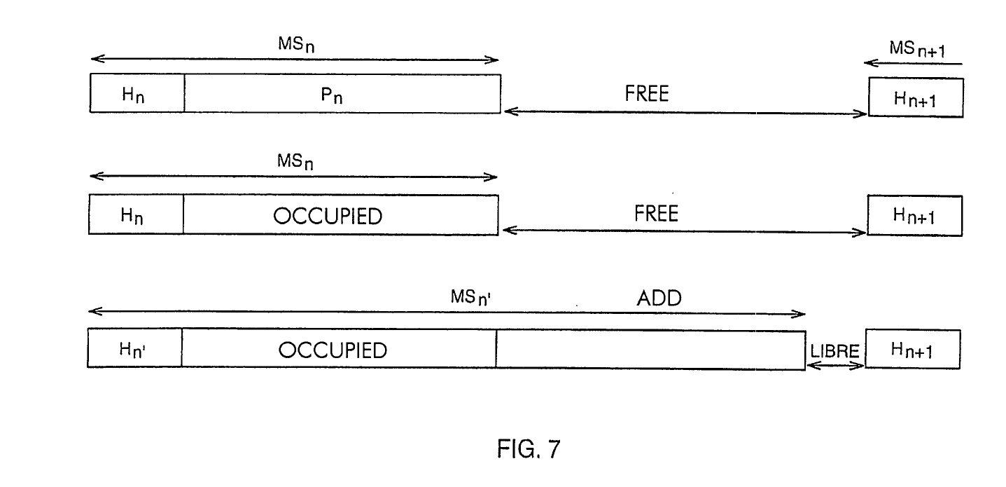

FIG. 7 is a diagram representing the addition of data packets to a macroslot of variable size,

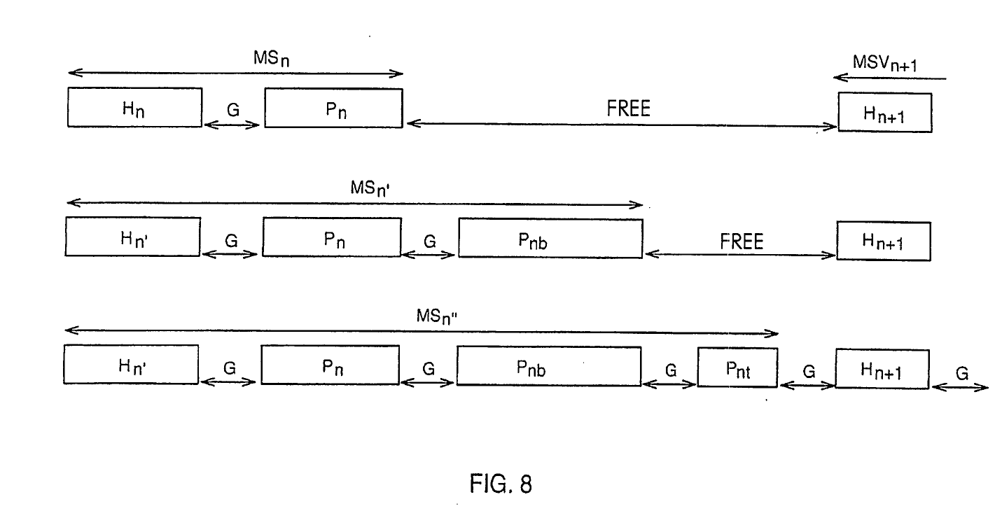

FIG. 8 is a diagram representing the addition of data packets to a macroslot of variable size in which a header and data elements are separated by guard bands, and

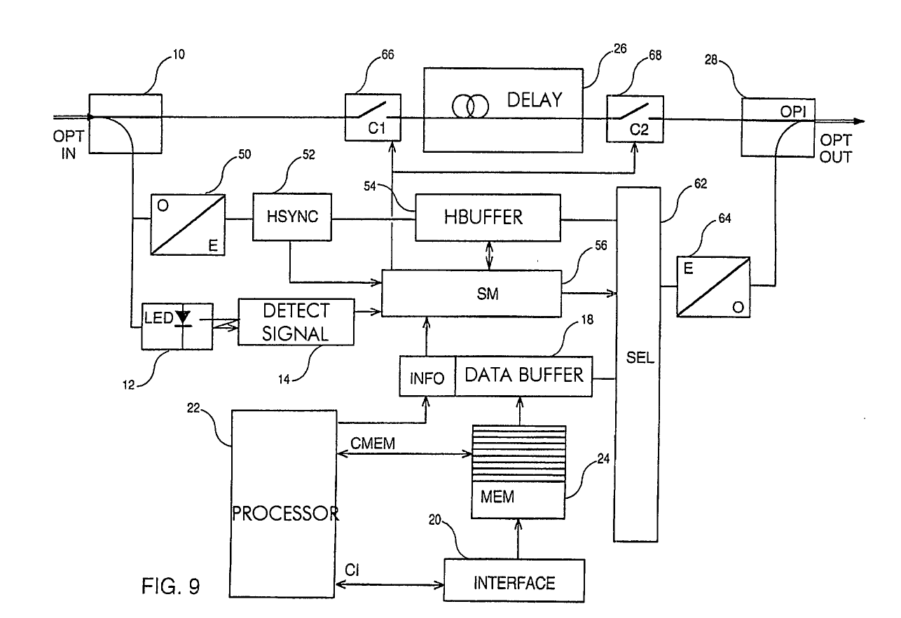

FIG. 9 is a block diagram representing a hybrid optical and electronic device for adding data to the frame at the interface of an intermediate node.

FIG. 1 shows a fiber optic data transmission network connecting a source node N1 and a destination node N5 via three intermediate nodes N2, N3 and N4. At the source node N1, data is added to an optical resource at the interface of the node N1. According to the invention, at the interface of each intermediate node N2, N3 or N4, data is added on the fly if the whole of the bandwidth has not been used. Finally, data for the destination node N5 is dropped at the interface of the node N5.

FIG. 2 shows one example of the addition of data packets by the intermediate nodes, on the assumption that the data takes the form of packets, which is generally the case. Note that, to simplify the figure, the packets sent in the three portions of the resource are slots corresponding to packets of fixed size. The same principle nevertheless applies in the case of packets of variable size, as described hereinafter.

The packets are designated Px, where x is the number of the intermediate node. At the source node N1, three slots 1, 5 and 9 are filled. At the intermediate node N2, data packets are added to the free slots 2 and 6. At the intermediate node N3, three packets are added to the remaining free slots 3, 4 and 7. Finally, at the intermediate node N4, a single packet may be added to the last free slot 8, even if the intermediate node N4 has a plurality of packets to send.

Different methods are used to add data packets to the free spaces of an optical stream according to the granularity of the optical resource switched at the nodes and the structure of the packets or slots added, and optical and digital variants of processing techniques are proposed as techniques for implementing the invention. In all embodiments, an added packet generally consists of a header and a “data” region. In the case of a macropacket, it will be necessary, firstly, to read the header of the macropacket (fixed or variable size) to find out its destination, and then to see if there is any free space for adding a new packet going to the same destination. It should be noted that, to achieve efficient optical switching at high bit rates, the routing information in the address header of the macropackets or macroslots must be analyzed quickly. The conventional method uses electronic header recognition, but it is also possible to use optical recognition. One method uses a reduced information density for the optical coding of macroslot packet headers. This facilitates decoding, interpretation, modification and regeneration of the new header at the required wavelength.

FIG. 3 shows one embodiment of an optical device for detecting a free space in order to add data to it at the interface of an intermediate node of the transmission network. This corresponds either to optical circuit switching or to time macroslot switching, for which the routing is predetermined so that no header reading is necessary to find out the final destination of the optical resource (wavelength or time macroslot) and simple analysis of the free portions is all that is necessary. Note that the packets may be of fixed or variable size.

In an all-optical system, like that shown in FIG. 3, it is necessary first of all to detect absences of signal transmission in the input optical signal OPT IN of the node concerned, in order to add signals in the free spaces. A small portion of the input optical signal is therefore sampled by an optical coupler (OPC) 10 which sends the sampled portion of the optical signal to a photodiode 12 that is coupled to a signal power detector 14 and indicates the presence or absence of optical signals. The mechanism amounts to measuring the power of the received signal. In the absence of a signal, the optical resource is free and the free space may be used. It is therefore possible to generate an optical packet corresponding to a duration less than the duration of the free space; the length of the packet must be less than or equal to this free space less two safety spaces known as guard bands.

A timer 16 is started by a signal detector 14 immediately the latter detects the absence of signals. The timer has a capacity corresponding to the size of a packet to be added and delivers an “enable” signal to a data buffer memory 18 unless it is reset by the signal detector 14 before it times out. This embodiment for adding a fixed length packet may be improved to enable addition of a variable length packet.

The data to be added to the free space of the frame is provided by an interface 20 under the control of a processor 22 and a control signal CI; so that it may be read and written, the data is stored in a memory 24 managed by a control signal CMEM.

To add the packet at the right location requires a delay line 26 corresponding to the analysis and processing time and placed on the main optical path, before it enters the addition device in which this signal and the signal created locally for the transmission of the added packet will be mixed. As its name indicates, the delay line delays the main signal by the time needed to analyze the free space, and its value must therefore be the time to add a packet plus a margin corresponding to the guard band. In the proposed scheme, the addition is effected by an optical insertion (OPI) coupler 28 following conversion of the data in the data buffer memory 18 by the electronic-optical converter 19. The output signal OPT OUT may be either the input signal to a global switching matrix of the node or the output signal of the node in an embodiment using only one wavelength.

Two different embodiments are possible at this level: the addition of packets of variable length regardless of the available space, with a minimum and a maximum, of course, and the addition of packets of fixed length if the free space is sufficient. The first embodiment optimizes the bandwidth and the second embodiment simplifies implementation. If a fixed length packet is to be added, the optical delay is of fixed size and corresponds to the size of the packet to be added plus the processing time and a margin corresponding to the guard bands. It is then necessary to wait for the timer to reach the size of the packets to free up the addition, as described later. If a variable packet is to be added, the optical delay corresponds to the maximum size of the packet to be inserted, plus the processing time and the guard bands, as before. It is then necessary for the information from the timer to be correlated with the information on the size of the packet loaded into the buffer memory to be sure that the free space is large enough compared to the size of the packet to be sent.

FIG. 3 represents the simple fixed size embodiment. How to adapt this solution to suit different packet sizes will be evident to the person skilled in the art.

The mechanism that has just been described may be applied when the optical network uses one or more wavelengths. It is sufficient to reproduce the FIG. 3 device independently for each wavelength.

The FIG. 4 flowchart shows the process of free space detection and processing implemented in the FIG. 3 device. The starting point 30 of the process is the detection of the change of state of the signal. A choice is made 32 according to whether there is a signal or not, which either stops the timer 34 or activates the timer 36. If the timer is activated, the process returns to waiting 30 for a change of state of the signal. After the timer has been stopped 34, the value it has reached is checked 38 to see if it is greater than the limit value IM, enabling the addition of a packet 40. The timer is then reset 42 before returning to the waiting state 30. If not, i.e. if the limit has not been reached, the timer is reset before returning to the waiting state 30. In the case of a packet of variable size, the procedure is the same, using a variable limit value set by the size of the packet in the buffer memory.

An alternative to the FIG. 3 all-optical device is to convert the input optical signal into an electrical signal in a converter 50 shown in FIG. 5. This corresponds to processing a macroslot comprising a routing header. The signal is forwarded to two subsystems: a mechanism for detecting and processing the header of the macropackets and a mechanism for detecting and processing the “data” portion of the macropacket. The packets or macroslots usable in this kind of environment are preferably of fixed size but may be of variable size, where applicable with guard bands inserted between the elements of the macroslot, as described hereinafter.

In this embodiment the header subsystem comprises a header synchronizer (HSYNC) 52 for extracting from the stream the header portion, which is stored in a buffer memory 54 which is under the control of a state machine (SM) 56 which is able to read and write certain fields of the header. The state machine determines if the frame has free portions merely by analyzing the header.

The embodiment proposed is a system for transmitting all the packets to a single destination and therefore a system adding data only if the macroslot destination address corresponds to the packet to be added. It is clear that the person skilled in the art will know how to add the necessary number of buffer memories (one per destination) and to select a buffer memory as a function of the address contained in the header of the macroslot.

The data subsystem comprises a data field synchronizer (PSYNC) 58 for extracting from the stream the data portion, which is stored in a transit buffer memory 60 under the control of the state machine (SM) 56 that is able to write certain fields in this memory and in particular to add data to that already present.

As previously, the proposed embodiment also prepares the data to be added to the packet and places it in the buffer memory 18. The data is supplied by the interface 20 under the control of the processor 22 and a set of control signals CI; the processor stores the data in a memory 24 managed by a control system CMEM to enable reading and writing in particular. The most urgent data that is to be transmitted is transferred from the memory 24 to the data buffer 18 by the packet processor 22, which also defines an information field INFO associated with the content of the buffer and that may be read by the state machine (SM) 56 in order to modify the header field. The information may be the length of the buffer (if it is variable) and the destination of the data, for example. The length of the data to be transmitted is also useful in respect of the time to select the buffer 18 during transmission. The present embodiment relates only to macropackets of fixed size. In the situation where the macropackets are of variable size, it is necessary to add a free space detection mechanism like that described above. If the header is modified, the state machine transmits the modified macropackets, i.e. it first transmits the new header in the header buffer (HBUFFER) 54 by means of an appropriate selection by the selector (SEL) 62, and then strings to the transmission of the data contained in the payload buffer (PBUFFER) 60 by means of another selection by the selector (SEL) 62, and finally finishes by transmitting the data stored in the data buffer memory 18. Finally, an electrical to optical converter 64 is used to return to the optical domain.

Note that the FIG. 3 all-electronic alternative could be envisaged merely by simplifying FIG. 5. It suffices for this purpose to eliminate the header processing portion and to retain the O/E converter 50, the transit buffer 60 for the original data, the data buffer memory 18 for the data to be added, and the selector 62. In this case, the buffer for data to be added is selected if the transit buffer memory is empty and all of the packet to be added is then serviced. If another packet in transit arrives, it is stored until the end of servicing the packet to be added, and is then serviced thereafter, and so on.

Note also that this mechanism can equally well concatenate the various fields or insert free spaces that correspond to the insertion of zeros at the selector (SEL) 62. Accordingly, this embodiment adapts to all packet structures as described, that is to say of fixed or variable length, with or without guard bands between the headers and the data, and with or without guard bands between different data regions. This is the advantage in relation to the manipulation of fields of an all-electronic structure.

Note that, in the embodiment shown in FIG. 5, the process of free space detection and processing includes almost the same steps as the all-optical embodiment depicted by the FIG. 4 flowchart, except that the processing is more complex and the timer is therefore replaced by a state machine that verifies that the structure and the size of the packet allow the addition of further data.

In the context of the invention, it is useful to use long frames to reduce the loss caused by the guard bands. However, this complicates the temporary storage of data and necessitates the ability to fill in the frames correctly. One solution is to use macroslots that meet these two constraints and optimize the filling of an optical fiber.

FIG. 6 shows a macroslot structure MS of this kind with no separation of the header H and the data portion P, which is therefore suitable for electronic processing as shown in FIG. 5. The example uses a macroslot of fixed size. Each macroslot “MSn” is separated from its neighbors by a guard band to enable optical switching of the macroslots in the intermediate nodes.

In the situation where the macroslot contains a free portion at the end of the data, as shown in the figure, it is possible to assign free resources for the transmission of data. The free slots within the macroslot may then be used by the intermediate node that detects them. The header Hₙ of the packet or the macroslot must be modified (H_{n′}) to reflect the addition of data. A new data field ADD is added to the data portion of the macroslot. A space L at the end of the macroslot usable by another node may yet remain free. The example does not specify whether the slots within the macroslot are of fixed or variable size because both these options are possible.

FIG. 7 shows a macroslot structure of variable size, with a free space separating the macroslot MSₙ from the macroslot MSₙ₊₁. If an intermediate node adds data ADD to the macroslot, the size of the latter is modified and it is then denoted MS_{n′}. As shown in the figure, the free space between the new macroslot and the next macroslot is then smaller. The advantage of this structure is that it varies the size of the macroslot as a function of the availability of the network. It is also necessary to propagate this information on the new length of the macropacket to the node controller to ensure correct switching in the optical matrix. FIG. 8 shows an alternative implementation of the macroslots, in which the structure of a macroslot uses guard bands to separate all the global header regions and the data elements. The advantage is being able to use a hybrid (optical and electronic) solution to implement the add function, which enables faster processing and switching.

A basic variable length macroslot MSₙ consists of a header Hₙ and a data element Pₙ separated by a guard band. A data element P_{nb} is added at an intermediate node, which may entail modification of the header, changing its designation from Hₙ to H_{n′}. There remains a free space ahead of the following macroslot that is larger than a guard band. A later node may use this free space. Accordingly, further addition of data Pₙₜ may be associated with further modification of the header, then denoted H_{n″}. According to this solution, the data additions may be of any size provided that there remains at least one guard band ahead of the next entity, without losing sight of the fact that the maximum size must be limited since it fixes the length of the delay line.

The variable size macroslot structure shown in FIG. 8 may be used in association with a hybrid device combining, as shown in FIG. 9, the principle of the optical processing device shown in FIG. 3 and the principle of the electronic processing device shown in FIG. 5. The original header may be deleted on the main path by using a switch 66 (for example an SOA optical gate). Existing data is retained in the optical domain by storing it in the delay line 26 and reintroducing it at the proper time by means of the coupler 28. In this situation, where the header is deleted and rewritten by the intermediate nodes, the optical power detection method is useful only in the case of variable macropackets, for detecting in advance the arrival of the next header (delay line 26). In the fixed length situation the size of the free space is known immediately, because the space occupied in the macropacket is known from the header and its size is fixed.

If the header of the macropacket is not rewritten, it is nevertheless necessary to detect and read the header to determine the destination of the macropacket, but the latter is not modified at the intermediate nodes. In this case, there is no need to delete the header on the transit path or to add a new header, but the optical power detection method must be used to ensure that the free space is sufficient for transmitting the new data packet.

As in FIG. 5, one data buffer per destination is used in the case of multiple destinations.

There is no data to be deleted to add data to the macroslot, because the space must be free, but the some principle of electronic addition described with reference to FIG. 5 is used. A delay is imposed on the main path equal to the time needed to process the header, and the added data is positioned on the fly after determining the length of the existing macroslot by detecting the signal or decoding the header, the data being ready in the buffer region 18 already.

This verifies the possibility of enlarging the macroslot if sufficient space exists between the end of the current macroslot and the header of the next macroslot. To this end, a small portion of the optical signal OPT IN is therefore sampled from the input optical signal by the sampling optical coupler (OPC) 10, which sends this portion of the optical signal to a photodiode 12 that is coupled to a signal power detector 14 that indicates the presence or absence of an optical signal. This mechanism amounts to measuring the power of the received signal. The presence or absence of a signal is transmitted to the state machine (SM) 56, which manages this state in order to allow or bar addition of data to the macroslot. This optical detection may be replaced by an analysis of the header that gives the length of the existing data element(s). On the other hand, in order to find out the remaining free space if the macroslots are of variable size, optical detection remains the simplest solution for verifying the free space.

Note that, if the header is rewritten, the state machine 56 operates the switch 66 so as to store only the wanted data in the delay line 26, using information from the signal detector 14 and information from the header.

In parallel with this, header decoding is activated by the optical to electronic converter 50 and the processing mechanism consisting of the header synchronizer 52 for synchronizing the header portion, which is then stored in the buffer memory 54 under the control of the state machine 56.

The proposed implementation also prepares the data to be added to the packet and places it in the buffer memory 18. The data is supplied by the interface 20 under the control of the processor 22 and a set of control signals CI and stored in a memory 24 managed by a control system CMEM. The most urgent data to be transmitted is transmitted from the memory 24 to the data buffer 18 via the processor 22, which further defines an information field INFO associated with the content of the buffer that may be read by the state machine (SM) 56 in order to modify the header field. The information may be the length of the buffer (if it is variable) and the destination of the data, for example. Knowing the length of the data to be transmitted is also useful in respect of the time to select the buffer 18 during transmission.

In the favorable case, the header of the macroslot is modified and a slot containing the corresponding data is added to the macroslot. The header of the macroslot contains the total macroslot length information in order to set up for detection of the header of the next packet. In the event of a size modification, this value is changed in the header. It is then necessary to substitute the new header for the original header.

If the header is modified, the state machine transmits the modified packet, i.e. it transmits first the new header situated in the HBUFFER buffer 54, thanks to appropriate selection by the selector (SEL) 62, so that the new header is added just before the arrival, via the coupler 28, of the data delayed by the delay line 26 (to maintain the guard band between the header and the first data packet of the macropacket), and finally the data in the buffer memory 18 and the HBUFFER buffer 54 is transmitted again thanks to appropriate selection by the selector (SEL) 62. For the elements coming from the selector 62, an electrical to optical converter 64 is used to return to the optical domain. The following optical coupler 28 may also be replaced by a switching matrix in the situation of rewriting the header. Note that instead of using an SOA, a fast 2×1 switch could be used, an input channel being used to add the new data—header (the old header is then blocked at the same time) and new packet(s)—and the other input channel allowing the “old” packets of the macropacket to pass through transparently. In this embodiment, as in the optical embodiment shown in FIG. 3, a safety space or guard band is retained between the header and the data of the corresponding macroslot, in addition to the usual guard bands between packets. The same applies to the addition of the data element to the macroslot: a guard band is necessary ahead of the original macroslot to avoid contention at addition time. This guard band is made up of zeros and, to identify more clearly each element of the macroslot, a header specific to each data element is used and further comprises a portion identifying the macroslot to which the element belongs.

1. Dynamic method of adding data at the nodes of a fiber optic transmission network comprising at least one source node, one destination node and a plurality of intermediate nodes, said nodes being connected by a fiber optic connection, said method comprising the following steps:
a) creating at the source node an optical resource comprising portions containing data packets addressed to said destination node and free portions that may be occupied by packets supplied by each of said intermediate nodes,
b) when said resource transits an intermediate node, detecting if said resource comprises free portions if said intermediate node has at least one data packet to transmit, and
c) adding said data packet to a free portion of the resource if said free portion may contain said data packet,
which method is characterized in that:
the step b) consists in detecting the absence of optical signals; and
the step c) consists in transmitting said data packet over the network if the step b) has detected absence of any optical signal for a time corresponding at least to the time of said data packet.

2. Method according to claim 1, wherein the optical data signals received by said intermediate node are delayed by a delay line for a time corresponding to the time needed to analyze and process said sampled portion of the optical signal.

3. Method according to claim 1, wherein the step b) comprises the following steps:
b1) converting the optical signal received by said intermediate node into an electronic signal,
b2) extracting the original data from said optical resource converted into an electronic signal and storing said data in a transit buffer memory, and
b3) detecting the absence of electronic signals if said transit buffer memory is empty.

4. Dynamic method of adding data at the nodes of a fiber optic transmission network comprising at least one source node, one destination node and a plurality of intermediate nodes, said nodes being connected by a fiber optic connection, said method comprising the following steps:
a) creating at the source node an optical resource comprising portions containing data packets addressed to said destination node and free portions that may be occupied by packets supplied by each of said intermediate nodes,
b) when said resource transits an intermediate node, detecting if said resource comprises free portions if said intermediate node has at least one data packet to transmit, and
c) adding said data packet to a free portion of the resource if said free portion may contain said data packet,
which method is characterized in that:
said optical resource is a macropacket comprising a header for at least determining the destination of said macropacket and data packets supplied at each of said intermediate nodes; and
the step b) consists in determining the free portions of said macropacket by analyzing the content of said header.

5. Method according to claim 4, wherein the step b) comprises the following steps:
b1) converting the optical signal received by said intermediate node into an electronic signal bearing said macropacket,
b2) extracting the header of said macropacket and storing said header in a header buffer memory,
b3) extracting the original data from said macropacket and storing said data in a transit buffer memory, and
b4) analyzing the header by means of a state machine to determine if said macropacket comprises a free portion sufficient for addition thereto of said data packet.

6. Method according to claim 4, wherein the step b) comprises the following steps:
b1) converting the optical signal received by said intermediate node into an electronic signal bearing said macropacket,
b2) extracting the header of said macropacket and storing said header in a header buffer memory,
b3) extracting the original data from said macropacket and storing said data in a transit buffer memory, and
b4) measuring in said transit buffer memory the absence of data signals or measuring the time elapsed before the arrival of a new header to determine if said macropacket comprises a free portion sufficient for addition thereto of said data packet.

7. Method according to claim 4, wherein the step c) comprises the following steps:
c1) modifying said header stored in buffer memory as a function of said data packet to be added to the macropacket,
c2) transmitting, under the control of said state machine, a new macropacket comprising said modified header, said original data and said data packet that was previously stored in a data buffer memory, and
c3) converting said new macropacket into an optical signal to be transmitted over the network.

8. Method according to claim 4, wherein the step c) comprises the following steps:
c1) modifying said header stored in transit buffer memory as a function of said data packet to be added to the macropacket,
c2) deleting the original header with the aid of a switch situated upstream or downstream of said delay line,
c3) constructing, under the control of said state machine, a new macropacket resulting from the construction of said modified header, said original data delayed by said optical delay line and said data packet that was previously stored in the data buffer memory.

9. Method according to claim 4, wherein the free portions of said macropacket are simply analyzed during the step b) consisting of:
b1) sampling a portion of the optical signal received by said intermediate node by means of a sampling coupler (OPC) to convert said portion into an electronic signal, the other portion of the signal remaining in the optical domain,
b2) extracting the header of said macropacket carried by said electronic signal and storing said header in a header buffer memory,
b3) analyzing the header by means of a state machine to determine the destination of said macropacket, and
b4) to determine the maximum duration of the data packet to be added, measuring in said sampled signal portion the time for which there is absence of signals.

10. Method according to claim 9, wherein said portion of the optical signal remaining in the optical domain is delayed in a delay line for a time corresponding to the time needed to analyze and process said sampled portion of the optical signal.

11. Method according to claim 9, wherein the step c) consists in transmitting over the network said data packet that was previously stored in data buffer memory if the step b) has detected absence of optical signals for a time corresponding at least to the time of said data packet.

12. System comprising means adapted to implement the steps of the method according to claim 1.

13. System comprising means adapted to implement the steps of the method according to claim 4.
